(19) United States
(12) Patent Application Publication
(10) Pub. No.: US 2006/0222848 A1
(43) Pub. Date: Oct. 5, 2006

(54) Fluoride coating compositions, methods for forming fluoride coatings, and magnets

(76) Inventors: Yuichi Satsu, Hitachi (JP); Matahiro Komuro, Hitachi (JP); Noboru Baba, Hitachiota (JP); Yuzo Kozono, Hitachiota (JP); Kunihiro Maeda, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/354,091

(22) Filed: Feb. 15, 2006

(30) Foreign Application Priority Data
Mar. 31, 2005 (JP) 2005-100485

(51) Int. Cl. H01F 1/00

(52) U.S. Cl. 428/403; 106/287.27; 106/287.23; 106/287.3; 252/62.51 R

(57) ABSTRACT

A fluoride coating composition forms a coating of a rare earth fluoride and/or an alkaline earth metal fluoride on a surface of an article to be coated. The composition contains the rare earth fluoride and/or alkaline earth metal fluoride, and a medium mainly containing at least one alcohol. In the composition, the rare earth fluoride and/or alkaline earth metal fluoride is swollen by the medium, is gelatinous, and is dispersed in the medium.

### CLAIM OF PRIORITY

This application claims priority from Japanese application serial No. 2005-100485, filed on Mar. 31, 2005, the content of which is hereby incorporated into this application.

### FIELD OF THE INVENTION

The present invention relates to fluoride coating compositions, methods for forming fluoride coatings, and magnets.

### BACKGROUND OF THE INVENTION

Conventional sintered rare earth magnets containing fluorine compounds are disclosed in Japanese Unexamined Patent Application Publication (JP-A) No. 2003-282312.

According to the conventional technique disclosed in the document, the fluorine compound constitutes a granular grain boundary phase and is not arranged along the grain boundaries of the magnet or surfaces of constitutive particles. The document lacks a description about a fluorine-containing layer which is continuously arranged in order to reduce eddy current and to secure energy product, and also lacks a description about a layer adjacent to the fluorine-containing layer.

The document fails to teach the use of inorganic fluorine compounds in powder magnetic cores.

When a sintered magnet is prepared by mixing a powder for NdFeB sintered magnet and a DyF₃ powder according to the conventional technique, the sintered magnet has a significantly reduced residual magnetic flux density due to an increased content of the DyF₃ powder and thereby has a reduced energy product ((BH)_{MAX}) as an index of magnetic properties as a magnet, although it can have an increased coercive force. Therefore, the magnet shows a low energy product despite of an increased coercive force and cannot be significantly used in magnetic circuits which require high magnetic fluxes. In addition, the magnet contains the fluorine-containing compound arranged discontinuously and is not expected to reduce the eddy current loss. In contrast, a powder magnetic core is compressed and molded under high pressure, thereby has strain in a soft magnetic powder and shows a greater hysteresis loss. To reduce the hysteresis loss, annealing of the magnetic core is effective. However, there has been no dielectric film having such a high thermal resistance to temperatures up to about 800° C. Even when a dielectric film is formed on the soft magnetic powder to reduce the eddy current loss, a core loss as a total of the hysteresis loss and the eddy current loss cannot be reduced at frequencies on the order of 1 kHz to 100 kHz.

After intensive investigations, the present inventors found that the eddy current can be effectively reduced without impairing the magnetic properties of magnets or powder magnetic cores by continuously forming a fluorine-containing layer with a suitable thickness.

They made further investigations and found that such a continuous fluorine-containing layer with a suitable thickness cannot be significantly formed according to conventional techniques. Accordingly, an object of the present invention is to form a continuous fluorine-containing layer with a suitable thickness.

### SUMMARY OF THE INVENTION

Specifically, the present invention provides, in an aspect, a coating composition for applying a fluoride coating to an article to be coated, which contains a rare earth fluoride and/or an alkaline earth metal fluoride, and a medium mainly containing at least one alcohol, in which the rare earth fluoride and/or alkaline earth metal fluoride is swollen by the medium to be gelatinous and the gelatinous rare earth fluoride and/or alkaline earth metal fluoride is dispersed in the medium.

In another aspect, the present invention provides a method for applying a film of a rare earth fluoride and/or an alkaline earth metal fluoride to an article to be coated, which method includes the step of bringing the article to be coated into contact with a fluoride coating composition containing the rare earth fluoride and/or alkaline earth metal fluoride, and a medium mainly containing at least one alcohol, in which the rare earth fluoride and/or alkaline earth metal fluoride is swollen by the medium to be gelatinous and the gelatinous rare earth fluoride and/or alkaline earth metal fluoride is dispersed in the medium so as to have an average particle diameter of 10 μm or less.

In addition and advantageously, the present invention provides a magnet containing magnetic particles which have been treated with the fluoride coating composition by the above-mentioned method.

According to the fluoride coating compositions, methods for applying a fluoride coating, and magnets of the present invention, a fluorine-containing layer can be continuously formed with a suitable thickness on an article to be coated.

Further objects, features and advantages of the present invention will become apparent from the following description of the preferred embodiments.

### DETAILED DESCRIPTION OF THE PREFERRED EMBODIMENTS

The present invention can increase the coercive force and the squareness in the second quadrant of a B-H loop of R-Fe-B or R- Co magnets, wherein R represents a rare earth element, to thereby improve the energy product. The magnets according to the present invention each comprise a metal or metal oxide and a highly water-resistant coating arranged on the surface thereof and have improved corrosion resistance. In addition, the magnets can have reduced eddy currents since they have insulating coatings on surfaces of magnetic particles. The coatings according to the present invention have thermostability to temperatures of about 1000° C. or higher, and the compositional powder magnetic cores can be annealed so as to reduce the hysteresis loss. Consequently, rare earth magnets or powder magnetic cores prepared by using magnetic particles for rare earth magnets or soft magnetic powders having the coating of the present invention can have reduced eddy current loss and hysteresis loss even when exposed to varying magnetic fields such as alternating magnetic fields, and can reduce heat generation caused by eddy current loss and hysteresis loss. Thus, they can be used typically in rotating machineries such as surface magnet motors and embedded magnet motors, and in MRI systems and current-limiting devices in which such magnets and magnetic cores are arranged in high-frequency magnetic fields.

To achieve the above objects, a layer containing a metal fluoride must be continuously formed along grain boundaries or powder surfaces while maintaining the magnetic properties. NdFeB magnets comprise Nd₂ Fe₁₄B as a principal phase and further comprise Nd phase and Nd_{1.1}Fe₄B₄ phase in phase diagram. By appropriately adjusting the composition of NdFeB and heating the resulting NdFeB, Nd phase or NdFe alloy phase is formed at grain boundaries. These Nd-rich phases are susceptible to oxidation to thereby yield an oxide layer partially. The fluoride-containing layer is arranged outside of the parent phase, i.e., the Nd phase, NdFe alloy layer or N doxide layer. The fluoride-containing layer comprises a layer containing at least one of alkaline earth metals and rare earth elements combined with fluorine. The fluorine-containing layer is arranged in contact with the Nd₂Fe₁₄B, Nd phase, NdFe phase, or Nd oxide layer. The Nd phase or NdFe phase has a lower melting point, is more susceptible to diffusion due to heating and more easily changes in structure than Nd₂Fe₁₄ B. The layer containing at least one fluoride of alkaline earth metals and rare earth elements should essentially have an average thickness greater than the thickness of the Nd phase, NdFe phase, or Nd oxide layer. This reduces the eddy current loss and achieves satisfactory magnetic properties. The Nd phase or NdFe phase (Nd₉₅Fe₅) forms at grain boundaries at a eutectic temperature of 665° C. For achieving the fluoride-containing layer that is stable even at such high temperatures, it is necessary to set the thickness of the fluoride-containing layer greater than that of the Nd phase or NdFe phase (Nd₉₅Fe₅) and arrange the fluoride-containing layer continuously in contact with the phase. This improves the thermostability of the fluoride-containing layer to thereby avoid instabilities such as introduction of defects from an adjacent layer due to heating and discontinuation of the layer. Powders of ferromagnetic materials comprising at least one of rare earth elements, such as NdFeB materials, are susceptible to oxidation due to the presence of the rare earth element. For higher handleability, magnets may be produced using oxidized powders. If the oxide layer has a large thickness, the magnetic properties and the stability of the fluoride-containing layer deteriorate. At a large thickness of the oxide layer, the fluoride-containing layer undergoes structural change during heat treatment at temperatures of 400° C. or higher. Specifically, diffusion and alloying between the fluoride-containing layer and the oxide layer (diffusion and alloying between fluoride and oxide) occur.

Materials to which the present invention can be applied will be described below. The fluoride-containing layer can comprise any of fluorides including CaF₂, MgF₂, LaF₃, CeF₃, PrF₃, NdF₃, SmF₃, EuF₃, GdF₃, TbF₃, DyF₃, HoF₃, ErF₃, TmF₃, YbF₃, and LuF₃; amorphous substances having the compositions of these fluorides; fluorides each comprising two or more elements constituting these fluorides; multicomponent fluorides corresponding to these fluorides, except with oxygen, nitrogen, and/or carbon; fluorides corresponding to these fluorides, except with constitutional elements containing impurities in the principal phase; and fluorides having fluorine contents lower than those of the above-mentioned fluorides. The fluoride-containing layer can be uniformly formed effectively by applying a solution to surfaces of ferromagnetic particles. Such magnetic particles for rare earth magnets are very susceptible to corrosion, and the metal fluoride may be formed by sputtering or vapor deposition. According to these techniques, however, it takes much time and efforts to form a metal fluoride layer having a uniform thickness, inviting higher cost. On the other hand, wet coating using an aqueous solution is not desirable, because magnetic particles for rare earth magnets easily form rare earth oxides. The present invention found that, by applying a solution mainly containing at least one alcohol, a layer of metal fluoride can be formed while inhibiting the corrosion of the magnetic particles for rare earth magnets, since such alcohols have high wettability to magnetic particles for rare earth magnets and can minimize ionic components which cause corrosion.

For the viewpoint of coating, it is undesirable that the metal fluoride is in solid state. If such a solid metal fluoride is applied to the magnetic particles for rare earth magnets, a continuous metal fluoride film cannot be formed on surfaces of the magnetic particles for rare earth magnets. The present inventors focused attention on a sol-gel reaction occurred when hydrofluoric acid is added to an aqueous solution containing rare earth and alkaline earth metal ions and found that such ionic components can be removed while replacing water as a medium with an alcohol. They further found that a gelatinous metal fluoride can be isolated by concurrently carrying out ultrasonic stirring, and that the resulting coating composition is optimum for forming a uniform film of metal fluoride on surfaces of magnetic particles for rare earth magnets.

The metal fluoride-containing layer can be formed in any process before and after heat treatment for yielding high coercive force. After covering the surfaces of magnetic particles for rare earth magnets with the fluoride-containing layer, the resulting article is subjected to magnetic-field orientation, heating and molding to thereby yield anisotropic magnets. Isotropic magnets can also be produced without applying magnetic fields for imparting anisotropy. Alternatively, bonded magnets can be prepared by heating the magnetic particles for rare earth magnets coated with the fluoride-containing layer at temperatures of 1200° C. or lower to impart high coercive force, and mixing the particles with organic materials to yield compounds. The ferromagnetic materials comprising rare earth elements can be powders comprising any of Nd₂Fe₁₄B, (Nd, Dy)₂Fe₁₄B, Nd₂(Fe, Co)₁₄B, and (Nd, Dy)₂(Fe, Co)₁₄B; these NdFeB substances further combined with Ga, Mo, V, Cu, Zr, Tb and/or Pr; Sm₂Co₁₇-based Sm₂ (Co, Fe, Cu, Zr)₁₇, and Sm₂Fe₁₇N₃. The rare earth fluoride and/or alkaline earth metal fluoride in the coating composition is swollen by a medium mainly comprising at least one alcohol. This is because the present inventors found that a gel of rare earth fluoride and/or alkaline earth metal fluoride has a flexible gelatinous structure and that alcohols have high wettability to magnetic particles for rare earth magnets. The gelatinous rare earth fluoride and/or alkaline earth metal fluoride should have an average particle diameter on the order of hundred micrometers to nanometers so as to easily yield a homogenous coating on surfaces of the magnetic particles for rare earth magnets. Additionally, the use of a medium mainly comprising at least one alcohol can inhibit oxidation of the magnetic particles for rare earth magnets that are very susceptible to oxidation.

Fluorides of some rare earth elements may become susceptible to gelatinization in the presence of water. In these cases, water may be added to the rare earth fluoride coating composition. Water is preferably added as a medium to the rare earth fluoride coating composition after replacing the medium with at least one alcohol. This is because such alcohols act to remove ionic components, and the removal of ionic components as impurities prevents the magnetic particles for rare earth magnets from oxidizing. If heat treatment is conducted under such conditions that the magnetic particles for rare earth magnets are susceptible to oxidation, a benzotriazole organic anticorrosive agent is effectively added to avoid the oxidation.

A suitable concentration of the rare earth fluoride and/or alkaline earth metal fluoride in the coating composition varies depending on the thickness of a film to be arranged on the magnetic particles for rare earth magnets, but the thickness has an upper limit so that the rare earth fluoride and/or alkaline earth metal fluoride is swollen by the medium mainly comprising at least one alcohol, the resulting gelatinous rare earth fluoride and/or alkaline earthmetal fluoride is divided and dispersed in the medium mainly comprising at least one alcohol so as to have an average particle diameter on the order of 100 μm to 1 nm. While the upper limit of the concentration will be described later, the rare earth fluoride and/or alkaline earth metal fluoride may be swollen by the medium mainly comprising at least one alcohol and present therein in a concentration of 200 g/dm³ to 1 g/dm³.

A suitable amount of the rare earth fluoride coating composition varies depending on the average particle diameter of the magnetic particles for rare earth magnets. When the magnetic particles for rare earth magnets have an average particle diameter of 0.1 to 500 μm, the amount of the rare earth fluoride coating composition is preferably 300 ml to 10 ml per 1 kg of the magnetic particles for rare earth magnets. If the amount is excessively large, it takes a long time to remove the medium, and the magnetic particles for rare earth magnets become susceptible to corrosion. If the amount is excessively small, the magnetic particles for rare earth magnets are not sufficiently fully wetted on their surfaces by the coating composition.

The magnetic particles for rare earth magnets can be any of rare earth-containing materials, such as Nd-Fe-B materials, Sm-Fe-N materials, and Sm-Co materials.

The present invention will be illustrated in further detail with reference to several Examples below which by no means limit the scope of the present invention.

### EXAMPLE 1

A series of coating compositions for rare earth fluoride or alkaline earth metal fluoride coating was prepared in the following manner.

(1) A salt having high solubility in water, such as lanthanum acetate or lanthanum nitrate in the case of lanthanum (La), was added to and fully dissolved in 100 mL of water using a shaker or ultrasonic stirrer.

(2)A chemically equivalent weight of 10% diluted hydrofluoric acid for chemical reaction to form LaF₃ was gradually added.

(3) The resulting mixture containing a gelatinous precipitate of LaF₃ was stirred for one hour or longer using an ultrasonic stirrer.

(4) After centrifuging at 4000 to 6000 rpm, the supernatant was removed, and a substantially same amount of methanol was added.

(5) The methanol mixture containing the gelatinous LaF₃ was fully stirred to yield a suspension and further stirred for one hour or longer using an ultrasonic stirrer.

(6) The procedures (4) and (5) were repeated three to ten times until no anions such as acetate ions and nitrate ions were detected.

(7) Finally, substantially transparent sol LaF₃ was obtained in the case of LaF₃. A methanol mixture having a LaF₃ concentration of 1 g/5 mL was used as a coating composition.

The other coating compositions for rare earth fluoride or alkaline earth metal fluoride coating were prepared and are shown in Table 1.

TABLE 1
Coating composition for rare earth fluoride or alkaline
earth metal fluoride coating

| | | Effective | | Average |
|---|---|---|---|---|
| | | concentration | | particle |
| | Properties of coating | as coating | | diameter |
| Component | composition | composition | Medium | (nm) |
| MgF₂ | colorless, transparent, | ≦300 g/dm³ | methanol | <100 |
| | somewhat viscous | | | |
| CaF₃ | whitish, somewhat viscous | ≦300 g/dm³ | methanol | 100 to 3000 |
| LaF₃ | translucent, viscous | ≦300 g/dm³ | methanol | 100 to 1000 |
| LaF₃ | whitish, somewhat viscous | ≦300 g/dm³ | ethanol | 100 to 2000 |
| LaF₃ | whitish | ≦300 g/dm³ | n-propyl | 100 to 3000 |
| | | | alcohol | |
| LaF₃ | whitish | ≦300 g/dm³ | iso-propyl | 100 to 5000 |
| | | | alcohol | |
| CeF₃ | viscous, whitish | ≦100 g/dm³ | methanol | 100 to 2000 |
| PrF₃ | yellowish green, | ≦100 g/dm³ | methanol | 100 to 1000 |
| | translucent, viscous | | | |
| NdF₃ | pale violet, translucent, | ≦200 g/dm³ | methanol | 100 to 1000 |
| | viscous | | | |
| SmF₃ | whitish | ≦200 g/dm³ | methanol | 300 to 10000 |
| EuF₃ | whitish | ≦200 g/dm³ | methanol | 300 to 10000 |
| GdF₃ | whitish | ≦200 g/dm³ | methanol | 300 to 10000 |
| TbF₃ | whitish | ≦300 g/dm³ | methanol | 300 to 10000 |
| DyF₃ | whitish | ≦300 g/dm³ | methanol | 300 to 10000 |
| DyF₃ | whitish | ≦200 g/dm³ | 50% by | 100 to 3000 |
| | | | weight | |
| | | | methanol | |
| | | | and 50% by | |
| | | | weight | |
| | | | water | |
| HoF₃ | pink, turbid | ≦150 g/dm³ | methanol | 300 to 10000 |
| ErF₃ | pink, turbid, somewhat | ≦200 g/dm³ | methanol | 300 to 10000 |
| | viscous | | | |
| TmF₃ | somewhat translucent, | ≦200 g/dm³ | methanol | 100 to 1000 |
| | viscous | | | |
| YbF₃ | somewhat translucent, | ≦200 g/dm³ | methanol | 100 to 1000 |
| | viscous | | | |
| LuF₃ | somewhat translucent, | ≦200 g/dm³ | methanol | 100 to 1000 |
| | viscous | | | |

As the magnetic particles for rare earth magnets, particles of NdFeB alloy were used. The magnetic particles have an average particle diameter of 100 μm and are magnetically anisotropic. Coatings of a rare earth fluoride and/or an alkaline earth metal fluoride were formed on the magnetic particles for rare earth magnets in the following manner.

In the case of NdF₃ coating: translucent sol having a NdF₃ concentration of 1 g/10 mL

(1) To 100 g of magnetic particles for rare earth magnets having an average particle diameter of 70 μm was added 15 mL of the NdF₃ coating composition and mixed until the whole magnetic particles for rare earth magnets were wetted.

(2) The medium methanol was removed at a reduced pressure of 2 to 5 torr from the NdF₃-coated magnetic particles for rare earth magnets coated in Step (1).

(3) The magnetic particles for rare earth magnets from which the medium had been removed in Step (2) were placed in a quartz boat and subjected to heat treatment at a reduced pressure of 1×10⁻⁵ torr at 200° C. for thirty minutes and at 400° C. for thirty minutes.

(4) The magnetic particles treated with heat in Step (3) were placed in a Macor (Corning Inc.) vessel with a lid and subjected to heat treatment at 800° C. at a reduced pressure of 1×10⁻⁵ torr for thirty minutes.

(5) The magnetic properties of the magnetic particles for rare earth magnets after heat treatment in Step (4) were determined.

(6) The magnetic particles for rare earth magnets after heat treatment in Step (4) were charged into a die, oriented in an inert gas atmosphere in a magnetic field of 10 kOe and heated, pressed and thus molded at a temperature of 700° C. and a molding pressure of 5 t/cm² to yield an anisotropic magnet 7 mm long, 7 mm wide and 5 mm thick.

(7) A pulsed magnetic field of 30 kOe or more was applied to the anisotropic magnet prepared in Step (6) in an anisotropic direction. The magnetic properties of the resulting magnet were determined.

A series of coatings of the other rare earth fluoride or an alkaline earth metal fluoride were formed, and magnets were prepared by Steps (1) to (7). The magnetic properties of these magnets were determined, and the results are shown in Table 2.

TABLE 2
Magnetic properties of magnets using magnetic particles coated with rare earth fluoride or
alkaline earth metal fluoride

| | | Amount of | | | | | | | | | |
|---|---|---|---|---|---|---|---|---|---|---|---|
| | | composition | | | Magnetic properties | | | Magnetic properties | | | |
| | | (mL) | | | of magnetic particles | | | and resistivity of magnet | | | |
| | | per 100 g | | | Residual | | Maximum | Residual | | Maximum | |
| Coating | | of | | | flux | Coercive | energy | flux | Coercive | energy | |
| compo- | | magnetic | Concentration | | density | force | product | density | force | product | Resistivity |
| sition | Component | particles | (g/dm³) | Medium | (kG) | (kOe) | (MGOe) | (kG) | (kOe) | (MGOe) | (mΩcm) |
| 1 | — | — | — | — | 11.0 | 15.0 | 23.2 | 9.9 | 15.0 | 18.8 | 0.15 |
| 2 | MgF₂ | 20 | 150 | methanol | 10.8 | 15.5 | 22.4 | 9.7 | 15.5 | 18.1 | 0.45 |
| 3 | CaF₃ | 20 | 150 | methanol | 11.2 | 16.5 | 24.0 | 10.1 | 16.5 | 19.4 | 0.40 |
| 4 | LaF₃ | 20 | 150 | methanol | 11.3 | 16.5 | 24.4 | 10.2 | 16.5 | 19.8 | 0.80 |
| 5 | LaF₃ | 20 | 150 | ethanol | 11.2 | 16.4 | 24.0 | 10.1 | 16.4 | 19.4 | 0.77 |
| 6 | LaF₃ | 20 | 150 | n-propyl | 11.2 | 16.2 | 23.9 | 10.1 | 16.2 | 19.4 | 0.70 |
| | | | | alcohol | | | | | | | |
| 7 | LaF₃ | 20 | 150 | i-propyl | 11.1 | 15.9 | 23.6 | 10.0 | 15.9 | 19.1 | 0.64 |
| | | | | alcohol | | | | | | | |
| 8 | CeF₃ | 30 | 100 | methanol | 11.0 | 15.5 | 23.4 | 9.9 | 15.5 | 19.0 | 0.91 |
| 9 | PrF₃ | 30 | 100 | methanol | 11.0 | 15.2 | 23.3 | 9.9 | 15.2 | 18.9 | 0.85 |
| 10 | NdF₃ | 20 | 150 | methanol | 11.0 | 16.0 | 23.5 | 9.9 | 16.0 | 19.0 | 0.95 |
| 11 | SmF₃ | 20 | 150 | methanol | 11.0 | 15.5 | 23.4 | 9.9 | 15.5 | 19.0 | 0.65 |
| 12 | EuF₃ | 20 | 150 | methanol | 11.0 | 15.5 | 23.4 | 9.9 | 15.5 | 19.0 | 0.58 |
| 13 | GdF₃ | 20 | 150 | methanol | 11.0 | 16.0 | 23.6 | 9.9 | 16.0 | 19.1 | 0.55 |
| 14 | TbF₃ | 20 | 150 | methanol | 11.1 | 18.0 | 23.9 | 10.0 | 18.0 | 19.4 | 0.55 |
| 15 | DyF₃ | 20 | 150 | methanol | 11.2 | 17.0 | 24.2 | 10.1 | 17.0 | 19.6 | 0.58 |
| 16 | DyF₃ | 20 | 150 | 50% by | 11.2 | 17.5 | 24.1 | 10.1 | 17.5 | 19.5 | 0.50 |
| | | | | weight | | | | | | | |
| | | | | methanol | | | | | | | |
| | | | | and 50% | | | | | | | |
| | | | | by weight | | | | | | | |
| | | | | water | | | | | | | |
| 17 | HoF₃ | 20 | 150 | methanol | 11.0 | 15.8 | 23.8 | 9.9 | 15.8 | 19.3 | 0.63 |
| 18 | ErF₃ | 20 | 150 | methanol | 11.0 | 15.5 | 23.5 | 9.9 | 15.5 | 19.0 | 0.65 |
| 19 | TmF₃ | 20 | 150 | methanol | 11.2 | 15.5 | 24.1 | 10.1 | 15.5 | 19.5 | 0.78 |
| 20 | YbF₃ | 20 | 150 | methanol | 11.0 | 15.5 | 23.5 | 9.9 | 15.5 | 19.0 | 0.83 |
| 21 | LuF₃ | 20 | 150 | methanol | 11.2 | 15.5 | 24.1 | 10.1 | 15.5 | 19.5 | 0.88 |

These results show that the magnetic particles coated with a rare earth fluoride or alkaline earth metal fluoride, and the anisotropic rare earth magnets using the magnetic particles have more excellent magnetic properties and higher resistivity than those of the magnetic particles without coating and the anisotropic rare earth magnet using these magnetic particles. Among them, the magnetic particles having a coating of TbF₃ or DyF₃ and the anisotropic rare earth magnets using the magnetic particles have significantly improved magnetic properties. The anisotropic rare earth magnets using the magnetic particles having a coating of LaF₃, CeF₃, PrF₃, NdF₃, TmF₃, YbF₃, or LuF₃ have significantly improved resistivity.

### EXAMPLE 2

Coating compositions for coating rare earth fluoride or an alkaline earth metal fluoride were prepared by the procedure of Example 1. The magnetic particles for rare earth magnets were prepared by quenching parent alloys having adjusted compositions to yield NdFeB amorphous ribbons and pulverizing the amorphous ribbons. Specifically, the parent alloys were melted on a rotating roll such as a single roll or twin roll and were quenched by spraying an inert gas such as argon gas. The atmosphere can be inert gas atmosphere, reducing atmosphere, or vacuum atmosphere. The resulting quenched ribbons are amorphous or mixtures of an amorphous substance and a crystalline substance. The ribbons were pulverized and classified so as to have an average particle diameter of 300 μm. The magnetic particles comprising amorphous substances became crystalline as a result of heating thereby yielded magnetic particles having a Nd₂Fe₁₄B phase as a principal phase.

A series of coatings of rare earth fluoride or alkaline earth metal fluoride coating was formed on the magnetic particles for rare earth magnets in the following manner.

In the case of LaF₃ coating: translucent sol having an LaF₃ concentration of 5 g/10 mL

(1) To 100 g of the magnetic particles for rare earth magnets having an average particle diameter of 300 μm was added 5 mL of the LaF₃ coating composition and mixed until the whole magnetic particles for rare earth magnets were wetted.

(2) The medium methanol was removed from the LaF₃-coated magnetic particles for rare earth magnets coated in Step (1) at a reduced pressure of 2 to 5 torr.

(3) The magnetic particles for rare earth magnets from which the medium had been removed in Step (2) were placed in a quartz boat and subjected to heat treatment at a reduced pressure of 1×10⁻⁵ torr at 200° C. for thirty minutes and at 400° C. for further thirty minutes.

(4) The magnetic particles treated with heat in Step (3) were placed in a Macor (Corning Inc.) vessel with a lid and subjected to heat treatment at 800° C. at a reduced pressure of 1×10⁻⁵ torr for thirty minutes.

(5) The magnetic properties of the magnetic particles after heat treatment in Step (4) were determined.

(6) The magnetic particles after heat treatment in Step (4) were mixed with 10 percent by volume of a solid epoxy resin (EPX 6136, Somar Corporation) having a size of 100 μm or less using a V mixer.

(7) The compound of the magnetic particles and the resin prepared in Step (6) was charged into a die, oriented in an inert gas atmosphere in a magnetic field of 10 kOe and heated, pressed and thus molded at a temperature of 70° C. and a molding pressure of 5 t/cm² to yield a bonded magnet 7 mm long, 7 mm wide and 5 mm thick.

(8) The resin in the bonded magnet prepared in Step (7) was cured at 170° C. in nitrogen gas for one hour.

(9) A pulsed magnetic field of 30 kOe or more was applied to the bonded magnet prepared in Step (8). The magnetic properties of the resulting magnet were determined.

A series of coatings of the other rare earth fluoride or an alkaline earth metal fluoride were formed, and magnets were prepared by Steps (1) to (9). The magnetic properties of these magnets were determined, and the results are shown in Table 3.

TABLE 3
Magnetic properties of magnets using magnetic particles coated with rare earth fluorides
or alkaline earth metal fluorides

| | | Amount of | | | | | | | | | |
|---|---|---|---|---|---|---|---|---|---|---|---|
| | | composition | | | Magnetic properties | | | Magnetic properties | | | |
| | | (mL) | | | of magnetic particles | | | and resistivity of magnet | | | |
| | | per 100 g | | | Residual | | Maximum | Residual | | Maximum | |
| Coating | | of | | | flux | Coercive | energy | flux | Coercive | energy | |
| compo- | | magnetic | Concentration | | density | force | product | density | force | product | Resistivity |
| sition | Component | particles | (g/dm³) | Medium | (kG) | (kOe) | (MGOe) | (kG) | (kOe) | (MGOe) | (mΩcm) |
| 1 | — | — | — | — | 6.5 | 12.0 | 10.5 | 5.7 | 12.0 | 8.1 | 5.6 |
| 2 | MgF₂ | 10 | 300 | methanol | 6.6 | 12.5 | 10.8 | 5.7 | 12.5 | 8.3 | 50 |
| 3 | CaF₃ | 10 | 300 | methanol | 6.5 | 12.9 | 10.6 | 5.7 | 12.9 | 8.2 | 40 |
| 4 | LaF₃ | 10 | 300 | methanol | 7.0 | 14.3 | 12.0 | 6.1 | 14.3 | 9.2 | 160 |
| 5 | LaF₃ | 10 | 300 | ethanol | 6.9 | 14.2 | 11.7 | 6.0 | 14.2 | 9.0 | 150 |
| 6 | LaF₃ | 10 | 300 | n-propyl | 6.9 | 14.0 | 11.6 | 6.0 | 14.0 | 8.9 | 120 |
| | | | | alcohol | | | | | | | |
| 7 | LaF₃ | 10 | 300 | i-propyl | 6.8 | 13.8 | 11.2 | 5.9 | 13.8 | 8.6 | 100 |
| | | | | alcohol | | | | | | | |
| 8 | CeF₃ | 30 | 100 | methanol | 6.7 | 12.9 | 10.7 | 5.8 | 12.9 | 8.2 | 210 |
| 9 | PrF₃ | 30 | 100 | methanol | 6.7 | 13.3 | 10.7 | 5.8 | 13.3 | 8.2 | 180 |
| 10 | NdF₃ | 15 | 200 | methanol | 6.8 | 13.5 | 10.9 | 5.9 | 13.5 | 8.4 | 220 |
| 11 | SmF₃ | 15 | 200 | methanol | 6.7 | 13.1 | 10.8 | 5.8 | 13.1 | 8.3 | 110 |
| 12 | EuF₃ | 15 | 200 | methanol | 6.7 | 13.2 | 10.8 | 5.8 | 13.2 | 8.3 | 84 |
| 13 | GdF₃ | 15 | 200 | methanol | 6.8 | 13.4 | 11.0 | 5.9 | 13.4 | 8.5 | 75 |
| 14 | TbF₃ | 10 | 300 | methanol | 6.9 | 14.1 | 11.6 | 6.0 | 14.1 | 8.9 | 75 |
| 15 | DyF₃ | 10 | 300 | methanol | 7.0 | 15.0 | 12.1 | 6.1 | 15.0 | 9.3 | 84 |
| 16 | DyF₃ | 15 | 200 | 50% by | 7.0 | 15.2 | 12.2 | 6.1 | 15.2 | 9.4 | 62 |
| | | | | weight | | | | | | | |
| | | | | methanol | | | | | | | |
| | | | | and 50% | | | | | | | |
| | | | | by weight | | | | | | | |
| | | | | water | | | | | | | |
| 17 | HoF₃ | 20 | 150 | methanol | 7.0 | 14.3 | 12.0 | 6.1 | 14.3 | 9.2 | 99 |
| 18 | ErF₃ | 15 | 200 | methanol | 6.8 | 14.5 | 11.7 | 5.9 | 14.5 | 9.0 | 110 |
| 19 | TmF₃ | 15 | 200 | methanol | 6.8 | 14.4 | 11.6 | 5.9 | 14.4 | 8.9 | 150 |
| 20 | YbF₃ | 15 | 200 | methanol | 6.8 | 14.3 | 11.3 | 5.9 | 14.3 | 8.6 | 170 |
| 21 | LuF₃ | 15 | 200 | methanol | 6.8 | 14.3 | 11.2 | 5.9 | 14.3 | 8.6 | 190 |

These results show that the quenched magnetic particles having coatings of rare earth fluoride or alkaline earth metal fluoride, and the rare earth bonded magnets using the quenched magnetic particles have more excellent magnetic properties and higher resistivities than those of the quenched magnetic particles without coating and the rare earth bonded magnet using the quenched magnetic particles. Among them, the quenched magnetic particles each having a coating of TbF₃, DyF₃, HoF₃, ErF₃, or TmF₃ and the rare earth bonded magnets using these magnetic particles have significantly improved magnetic properties. The quenched magnetic particles each having a coating of LaF₃, CeF₃, PrF₃, NdF₃, SmF₃, ErF₃, TmF₃, YbF₃, or LuF₃, and the rare earth bonded magnets using the quenched magnetic particles have significantly increased resistivities.

### EXAMPLE 3

CaF₂ or LaF₃ coating compositions for coating rare earth fluoride or alkaline earth metal fluoride having a concentration of 150 g/dm³ were prepared by the procedure of Example 1. Iron powder, Fe-7% Si powder, Fe-50% Ni powder, Fe-50% Co powder, and Fe-X% Si-X% Al powder having average particle diameters of 60 μm, 10 μm, 10 μm, 10 μm, 30 μm, and 20 μm, respectively were used as soft magnetic powders.

A LaF₃ coating was formed in the following manner.

(1) To 1 kg of a soft magnetic powder was added 100 mL of the LaF₃ coating composition and the mixture was stirred until the whole soft magnetic powder was wetted.

(2) The medium methanol was removed at a reduced pressure of 2 to 5 torr from the soft magnetic powder having a coating of LaF₃ coated in Step (1).

(3) The soft magnetic powder from which the medium had been removed in Step (2) was placed in a quartz boat and subjected to heat treatment at a reduced pressure of 1×10⁻⁵ torr at 200° C. for thirty minutes and at 400° C. for thirty minutes.

(4) The soft magnetic powder prepared in Step (3) was charged into a die, molded at a molding pressure of 15 t/cm² to yield a ring test piece for evaluation of magnetic properties having an outer diameter of 28 mm, an inner diameter of 20 mm, and a thickness of 5 mm.

(5) The test piece prepared in Step (4) was annealed at 900° C. in a nitrogen gas atmosphere for four hours.

(6) The electric properties and magnetic properties of the test piece (powder magnetic core) after heat treatment in Step (5) were determined.

TABLE 4
Electric and magnetic properties of powder magnetic cores using soft magnetic powders coated
with rare earth fluorides or alkaline earth metal fluorides

| | | Composition | Resistivity | | Core loss | | | Core loss | | |
|---|---|---|---|---|---|---|---|---|---|---|
| | | of soft | of soft | Resistivity | (kW/m³), 500 kHz, 0.1 T | | | (kW/m³), 1 MHz, 0.1 T | | |
| | | magnetic | magnetic | of powder | Eddy | | | Eddy | | |
| Coating | | powder | powder | magnetic | current | Hysteresis | | current | Hysteresis | |
| composition | Component | (% by weight) | (Ωm) | core (Ωm) | loss | loss | Core loss | loss | loss | Core loss |
| 1 | CaF₂ | Fe | 0.12 × 10⁻⁶ | 1200 × 10⁻⁶ | 1.3 × 10⁴ | 0.2 × 10⁴ | 1.5 × 10⁴ | 4.2 × 10⁴ | 0.4 × 10⁴ | 4.6 × 10⁴ |
| 2 | CaF₂ | Fe—7% Si | 2.4 × 10⁻⁶ | 48000 × 10⁻⁶ | 1.0 × 10⁴ | 0.07 × 10⁴ | 1.1 × 10⁴ | 2.2 × 10⁴ | 0.1 × 10⁴ | 2.3 × 10⁴ |
| 3 | CaF₂ | Fe—50% Ni | 0.45 × 10⁻⁶ | 6800 × 10⁻⁶ | 1.2 × 10⁴ | 0.2 × 10⁴ | 1.4 × 10⁴ | 3.1 × 10⁴ | 0.4 × 10⁴ | 3.5 × 10⁴ |
| 4 | CaF₂ | Fe—50% Co | 0.50 × 10⁻⁶ | 7500 × 10⁻⁶ | 1.2 × 10⁴ | 0.2 × 10⁴ | 1.4 × 10⁴ | 3.0 × 10⁴ | 0.4 × 10⁴ | 3.4 × 10⁴ |
| 5 | CaF₂ | Fe—10% Si—5% | 2.0 × 10⁻⁶ | 40000 × 10⁻⁶ | 1.0 × 10⁴ | 0.2 × 10⁴ | 1.2 × 10⁴ | 2.3 × 10⁴ | 0.4 × 10⁴ | 2.7 × 10⁴ |
| | | Al | | | | | | | | |
| 6 | CaF₂ | Fe—10% | 2.5 × 10⁻⁶ | 51000 × 10⁻⁶ | 1.0 × 10⁴ | 0.05 × 10⁴ | 1.1 × 10⁴ | 2.1 × 10⁴ | 0.1 × 10⁴ | 2.2 × 10⁴ |
| | | Si—10% B | | | | | | | | |
| 7 | LaF₃ | Fe | 0.12 × 10⁻⁶ | 450 × 10⁻⁶ | 1.5 × 10⁴ | 0.2 × 10⁴ | 1.7 × 10⁴ | 6.2 × 10⁴ | 0.4 × 10⁴ | 6.6 × 10⁴ |
| 8 | LaF₃ | Fe—7% Si | 2.4 × 10⁻⁶ | 12000 × 10⁻⁶ | 1.1 × 10⁴ | 0.07 × 10⁴ | 1.2 × 10⁴ | 2.7 × 10⁴ | 0.1 × 10⁴ | 2.8 × 10⁴ |
| 9 | LaF₃ | Fe—50% Ni | 0.45 × 10⁻⁶ | 1900 × 10⁻⁶ | 1.3 × 10⁴ | 0.2 × 10⁴ | 1.5 × 10⁴ | 3.7 × 10⁴ | 0.4 × 10⁴ | 4.1 × 10⁴ |
| 10 | LaF₃ | Fe—50% Co | 0.50 × 10⁻⁶ | 2500 × 10⁻⁶ | 1.3 × 10⁴ | 0.2 × 10⁴ | 1.5 × 10⁴ | 3.5 × 10⁴ | 0.4 × 10⁴ | 3.9 × 10⁴ |
| 11 | LaF₃ | Fe—10% Si—5% | 2.0 × 10⁻⁶ | 9000 × 10⁻⁶ | 1.1 × 10⁴ | 0.2 × 10⁴ | 1.3 × 10⁴ | 2.9 × 10⁴ | 0.4 × 10⁴ | 3.3 × 10⁴ |
| | | Al | | | | | | | | |
| 12 | LaF₃ | Fe—10% | 2.5 × 10⁻⁶ | 13000 × 10⁻⁶ | 1.1 × 10⁴ | 0.05 × 10⁴ | 1.2 × 10⁴ | 2.8 × 10⁴ | 0.1 × 10⁴ | 2.9 × 10⁴ |
| | | Si—10% B | | | | | | | | |

These results show that the powder magnetic cores prepared by using soft magnetic powders each having a coating of rare earth fluorides or alkaline earth metal fluorides can maintain high resistivities after heating and annealing, since the coatings of rare earth fluorides or alkaline earth metal fluorides have high thermostabilities. Consequently, the powder magnetic cores have low eddy current losses and low hysteresis losses and thereby have low core losses at different frequencies, since the core loss is the total of the eddy current loss and the hysteresis loss.

### EXAMPLE 4

A series of NdFeB sintered compacts was produced by the following process. Nd powder, Nd-Fe alloy powder, and Fe-B alloy powder as raw materials containing Nd, Fe, and B were melted in vacuo or in an inert gas such as argon gas typically using a high-frequency induction system. In this procedure, Tb and/or Dy as rare earth elements for higher coercive force; Ti, Nb, and/or V for more stable structure; and/or Co for securing sufficient corrosion resistance and magnetic properties may be added according to necessity. The molten parent alloys were roughly crushed typically using a stamping mill or jaw crusher, pulverized typically using a Brown mill, and further finely pulverized typically using a jet mill. The resulting articles were oriented in a magnetic field of 20 kOe or less so as to align an easily-magnetizable direction along the magnetic field and were sintered at 400° C. to 1200° C. under reduced pressure or an inert gas atmosphere while pressurizing at a pressure of 0.1 t/cm² to 20 t/cm² to yield molded articles 10 mm long, 10 mm wide and 5 mm thick. The molded articles were magnetized in a magnetic field of 20 kOe or more to a magnetization rate of 95% or more in an anisotropic direction (the longitudinal direction or widthwise direction). The relation between the magnetization magnetic field and the flux was determined using a flux meter to thereby evaluate the magnetization rate.

LaF₃ or NdF₃ coating compositions having a LaF₃ or NdF₃ concentration of 1 g/dm³ prepared by the procedure of Example 1 were used as coating compositions for rare earth fluoride coatings.

(1) A block of the NdFeB sintered compact was immersed in the LaF₃ coating composition, and the medium methanol was removed at a reduced pressure of 2 to 5 torr from the block.

(2) Step (1) was repeated a total of five times.

(3) A pulsed magnetic field of 30 kOe or more was applied to the anisotropic magnet bearing the surface coating formed in Step (2) in an anisotropic direction.

(4) The anisotropic magnet prepared in Step (3) was subjected to a salt spray testor a pressure cooker test (PCT) under following conditions.

Salt spray test: 5% NaCl, 35° C., 200 hours

PCT: 120° C., 2 atm, 100% RH, 1000 hours

(5) The magnetic properties of the magnet after the salt spray test or PCT in Step (4) were determined.

TABLE 5
Accelerated deterioration test of rare earth magnets
coated with rare earth fluoride or alkaline earth metal fluoride

| | | | Residual | | Maximum |
|---|---|---|---|---|---|
| Coating | | Accelerated | flux | Coercive | energy |
| compo- | | deterioration | density | force | product |
| sition | Component | test | (T) | (kOe) | (MGOe) |
| 1 | LaF₃ | salt spray | 1.30 | 35 | 40 |
| | | test | | | |
| 2 | LaF₃ | PCT | 1.32 | 36 | 41 |
| 3 | NdF₃ | salt spray | 1.30 | 35 | 40 |
| | | test | | | |
| 4 | NdF₃ | PCT | 1.32 | 36 | 41 |
| 5 | — | salt spray | 1.20 | 30 | 35 |
| | | test | | | |
| 6 | — | PCT | 1.25 | 32 | 36 |

The resulting magnetized molded article was sandwiched between magnetic poles of a direct-current M-H loop measuring device so that the magnetization direction agrees with the application direction of magnetic field. A magnetic field was then applied between the magnetic poles, and a demagnetization curve was plotted. An FeCo alloy was used as pole pieces of the magnetic poles for applying the magnetic field to the magnetized molded article. The magnetization levels were calibrated using a pure nickel test piece and a pure iron test piece having the same dimensions as the tested magnet. Separately, an alternating magnetic field of 1 kOe at a frequency of 1 kHz was applied to the molded article 10 mm long, 10 mm wide and 5 mm thick by placing the magnet in a closed magnetic circuit and connecting an alternating-current power source to a wound coil, and the magnetic properties of the magnet were determined.

The results show that blocks of NdFeB sintered compacts having coatings of rare earth fluorides show no deterioration in residual magnetic flux density, coercive force, and maximum energy product even after the salt spray testor PCT. In contrast, the blocks of NdFeB sintered compacts without coating show significantly impaired magnetic properties. In particular, they show red rust after the salt spray test. In above Examples, the coatings on surfaces of magnetic particles have been taken as an example. However, the coating compositions and methods for coating according to the present invention can also be applied to coating of dielectric films on surfaces of substrates in semiconductor devices.

As is described above, the magnetic particles, magnetic metal plates, and magnetic metal blocks having surfaces bearing coatings of rare earth fluorides and/or alkaline earth metal fluorides 1 μm to 1 nm thick according to the present invention are more excellent in magnetic properties, electric properties, and reliability than magnetic particles, magnetic metal plates, and magnetic metal blocks without coating.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A fluoride coating composition for applying a coating of a rare earth fluoride and/or an alkaline earth metal fluoride to a surface of an article to be coated, comprising:
the rare earth fluoride and/or alkaline earth metal fluoride; and
a medium mainly comprising at least one alcohol,
wherein the rare earth fluoride and/or alkaline earth metal fluoride is swollen by the medium, is gelatinous and is dispersed in the medium.

2. The fluoride coating composition of claim 1, wherein the article to be coated is at least one selected from the group consisting of magnetic powders, magnetic metal plates, and magnetic metal blocks.

3. The fluoride coating composition of claim 1, wherein the gelatinous rare earth fluoride and/or alkaline earth metal fluoride has an average particle diameter of 10 μm or less.

4. The fluoride coating composition of claim 1, wherein the alcohol is at least one selected from the group consisting of methyl alcohol, ethyl alcohol, n-propyl alcohol, and isopropyl alcohol.

5. The fluoride coating-composition of claim 1, wherein the medium comprises:
50 percent by weight or more of at least one selected from the group consisting of methyl alcohol, ethyl alcohol, n-propyl alcohol, and isopropyl alcohol;
50 percent by weight or less of water; and
1 percent by weight or less of an organic, nitrogen-containing anticorrosive agent.

6. The fluoride coating composition of claim 1, wherein the rare earth fluoride and/or alkaline earth metal fluoride is a metal fluoride comprising at least one selected from the group consisting of La, Ce, Pr, Nd, Sm, Eu, Gd, Tb, Dy, Ho, Er, Tm, Yb, Lu, Mg, Ca, Sr, and Ba.

7. The fluoride coating composition of claim 1, wherein the rare earth fluoride and/or alkaline earth metal fluoride is swollen by the medium and has a concentration in the medium of 1 g/dm³ to 300 g/dm³.

8. A method for forming a coating of a rare earth fluoride and/or an alkaline earthmetal fluoride on an article to be coated, comprising the step of bringing the article to be coated into contact with a fluoride coating composition,
the fluoride coating composition comprising:
the rare earth fluoride and/or alkaline earth metal fluoride; and
a medium mainly comprising at least one alcohol,
wherein the rare earth fluoride and/or alkaline earth metal fluoride is swollen by the medium, is gelatinous and is dispersed in the medium so as to have an average particle diameter of 10 μm or less.

9. The method of claim 8, wherein the article to be coated is at least one selected from the group consisting of magnetic powders, magnetic metal plates, and magnetic metal blocks.

10. The method of claim 8, wherein the alcohol is at least one selected from the group consisting of methyl alcohol, ethyl alcohol, n-propyl alcohol, and isopropyl alcohol.

11. The method of claim 8, wherein the medium comprises:
50 percent by weight or more of at least one selected from the group consisting of methyl alcohol, ethyl alcohol, n-propyl alcohol, and isopropyl alcohol;
50 percent by weight or less of water; and
1 percent by weight or less of an organic, nitrogen-containing anticorrosive agent.

12. The method of claim 8, wherein the rare earth fluoride and/or alkaline earth metal fluoride is a metal fluoride comprising at least one selected from the group consisting of La, Ce, Pr, Nd, Sm, Eu, Gd, Tb, Dy, Ho, Er, Tm, Yb, Lu, Mg, Ca, Sr, and Ba.

13. The method of claim 8, wherein the rare earth fluoride and/or alkaline earth metal fluoride is swollen by the medium and has a concentration in the medium of 1 g/dm³ to 200 g/dm³.

14. The method of claim 8, further comprising bringing 1 kg of the article to be coated into contact with 10 ml to 300 ml of the fluoride coating solution, the article to be coated having an average particle diameter of 500 μm to 0.1 μm.

15. A magnet comprising magnetic particles, wherein the magnetic particles have been treated with a coating composition comprising:
the rare earth fluoride and/or alkaline earth metal fluoride; and
a medium mainly comprising at least one alcohol,
wherein the rare earth fluoride and/or alkaline earth metal fluoride is swollen by the medium, is gelatinous, is dispersed in the medium so as to have an average particle diameter of 10 μm or less.
